(19) United States
(12) Patent Application Publication
(10) Pub. No.: US 2013/0223053 A1
(43) Pub. Date: Aug. 29, 2013

(54) Drive Circuit Board Connection Structure for LED Lamp Tube

(71) Applicants: Chun-Chen LIU, Jhubei City (TW); Hsiao-Lan CHIN, Jhubei City (TW)

(72) Inventors: Chun-Chen LIU, Jhubei City (TW); Hsiao-Lan CHIN, Jhubei City (TW)

(21) Appl. No.: 13/597,982

(22) Filed: Aug. 29, 2012

(30) Foreign Application Priority Data
Feb. 23, 2012 (TW) 101203248

(51) Int. Cl. F21V 21/00

(52) U.S. Cl. 362/217.17

(57) ABSTRACT

An improved drive circuit board connection structure for light emitting diode (LED) lamp tube, wherein the LED lamp tube comprises a lamp tube body, at least an LED lamp strap installed inside the lamp tube body, and at least a drive circuit board installed on either side of the lamp tube body and electrically connected to the LED lamp strap. A connection plug component is respectively installed on the drive circuit board and the LED lamp strap, with each of the two different connection plug component individually having a male plug connection structure or female plug connection structure. Therefore, when such two different connection plug components are connected, it is possible to electrically connect the drive circuit board to the LED lamp strap and drive the LED lamp strap to illuminate.

The current application claims a foreign priority to the patent application of Taiwan No. 101203248 filed on Feb. 23, 2012.

### BACKGROUND OF THE INVENTION

1. Field of the Invention

The present invention generally relates to an improved drive circuit board connection structure for light emitting diode (LED) lamp tube; in particular, it relates to a connection structure facilitating more convenient connections between a drive circuit board and an LED lamp strap.

2. Description of Related Art

Featuring many advantages such as better power saving, longer life span, smaller size and faster reaction speed or the like, light emitting diodes (LEDs) are at present comprehensively applied in various illumination fields. Now certain manufacturers have developed the LED lamp tube allowable for replacement of fluorescent lamps. For a conventional LED lamp tube 1, it is typical to install at least an LED lamp strap 12 including a plurality of LEDs 121 inside a lamp tube body 11, and further install a drive circuit board 13 connected to the LED lamp strap 12 on either side of the interior of the lamp tube body 11 thereby driving the LED lamp strap 12 for light emissions.

As shown in FIGS. 1 and 2, two connection lines 14 are soldered onto the drive circuit board 13, and the other end of the connection line 14 is soldered onto the LED lamp strap 12. In this way, the drive circuit board 13 can be electrically connected to the LED lamp strap 12 by means of the connection lines 14 to conduct electric power.

However, with regards to the aforementioned circuit layout, it is necessary to solder the connection line 14 between the drive circuit board 13 and the LED lamp strap 12 before assembly operations. But, generally speaking, the distance from the drive circuit board 13 to the LED lamp strap 12 tends to be relatively short, thus that, to perform soldering processes on the connection line 14 within such a short distance between the drive circuit board 13 to the LED lamp strap 12, technically it would be pretty challenging for operators. In order to facilitate convenient assembly operations, operators usually solder overly long connection line 14 between the drive circuit board 13 and the LED lamp strap 12; whereas, after completion of assembly operations, the connection lines 14 of excessive length may by squeezed together, causing bending or entanglement problems among such two connection lines 14. In such a case, it is more likely to generate interference issues between connection lines. Accordingly, the controls over the length of the connection line 14 have to be appropriately and prudently enforced by manufacturers.

As such, it would an optimal solution if a corresponding connection structure can be respectively installed on the drive circuit board and the LED lamp strap, and the drive circuit board and the LED lamp strap can be electrically connected by connecting such two corresponding connection structures thereby eliminating inconvenience in assembly operations and/or interferences between connection lines.

### SUMMARY OF THE INVENTION

The present invention allows the installation of a corresponding connection plug component respectively on the drive circuit board and the LED lamp strap, and also the electrical connections between the drive circuit board and the LED lamp strap by connecting such two corresponding connection plug components.

An improved drive circuit board connection structure for light emitting diode (LED) lamp tube capable of achieving the above-said objectives is disclosed, wherein the LED lamp tube comprises a lamp tube body, at least an LED lamp strap installed inside the lamp tube body, and at least a drive circuit board installed on either side of the lamp tube body and electrically connected to the LED lamp strap, characterized in that: a connection plug component is respectively installed on the drive circuit board and the LED lamp strap, and by connecting such two different connection plug components, the drive circuit board and the LED lamp strap can be electrically connected thereby driving the LED lamp strap to illuminate.

More specifically, the connection plug component on the aforementioned drive circuit board includes at least a male plug connection structure, and the connection plug component on the LED lamp strap is formed with at least a female plug connection structure in correspondence with the male plug connection structure.

More specifically, in addition to the configuration set forth as above, the connection plug component on the aforementioned drive circuit board may also include at least a female plug connection structure, and the connection plug component on the LED lamp strap is formed with at least a male plug connection structure in correspondence with the female plug connection structure.

More specifically, the aforementioned male plug connection structure may be a pin header and the female plug connection structure may be a female header, and the electrical connection can be accomplished upon inserting the male plug connection structure to the female plug connection structure.

More specifically, the aforementioned LED lamp strap includes a plurality of LEDs.

More specifically, the aforementioned lamp tube body is of a long-strapped shape.

### BRIEF DESCRIPTION OF THE DRAWINGS

FIG. 1 shows a stereo structural diagram of a prior art LED lamp tube;

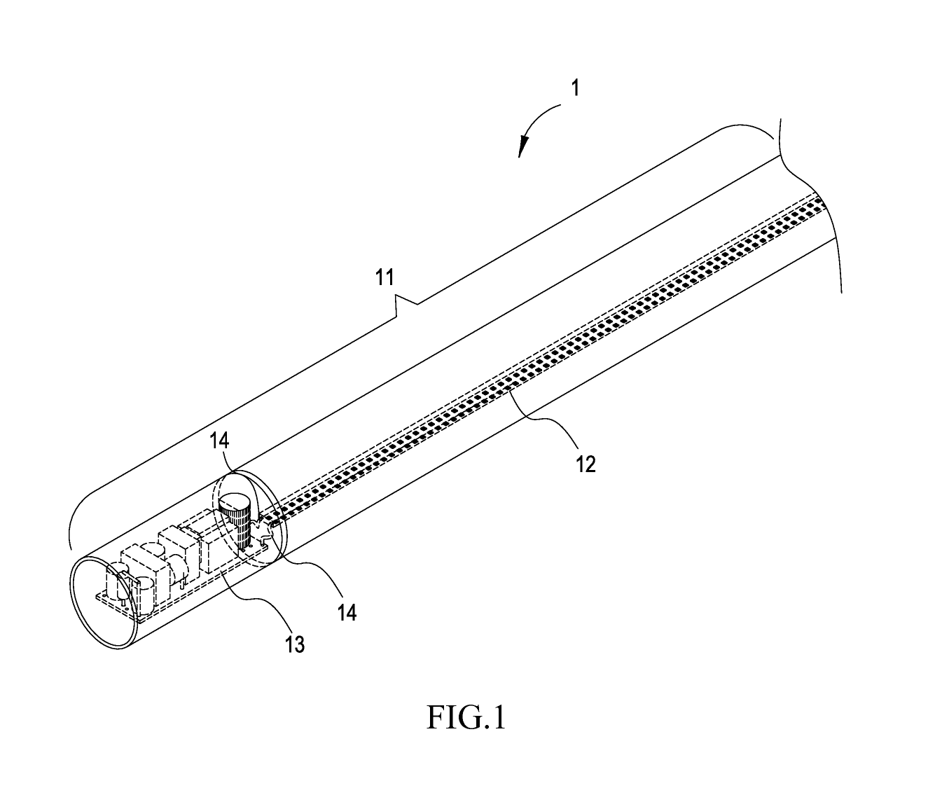

FIG. 2 shows a structural top view of a prior art LED lamp tube;

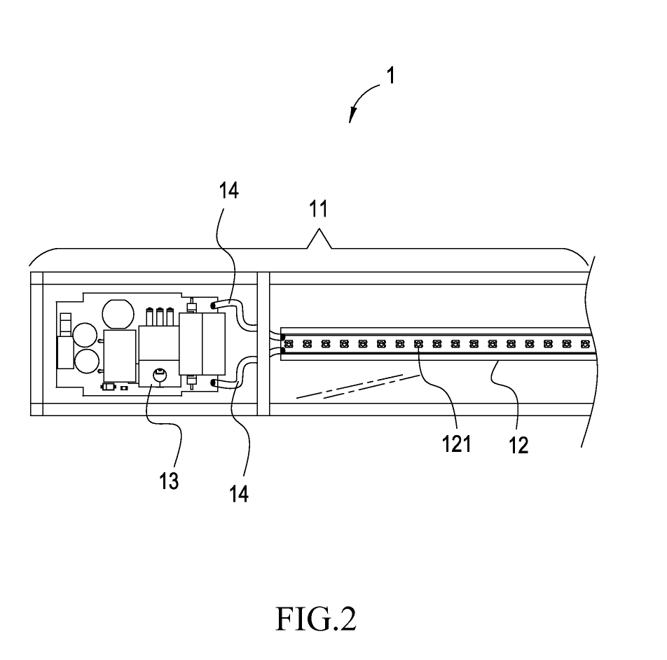

FIG. 3A shows a stereo assembled structural diagram for a first embodiment of the improved drive circuit board connection structure for LED lamp tube according to the present invention;

FIG. 3B shows a stereo disassembled structural diagram for a first embodiment of the improved drive circuit board connection structure for LED lamp tube according to the present invention;

FIG. 4 shows a side view for the first embodiment of the improved drive circuit board connection structure for LED lamp tube according to the present invention;

FIG. 5A shows a stereo assembled structural diagram for a second embodiment of the improved drive circuit board connection structure for LED lamp tube according to the present invention;

FIG. 5B shows a stereo disassembled structural diagram for the second embodiment of the improved drive circuit board connection structure for LED lamp tube according to the present invention;

FIG. 6 shows a side view for the second embodiment of the improved drive circuit board connection structure for LED lamp tube according to the present invention; and

FIG. 7 shows a side view for a third embodiment of the improved drive circuit board connection structure for LED lamp tube according to the present invention.

### DETAILED DESCRIPTION OF THE PREFERRED EMBODIMENTS

The aforementioned and other technical contents, aspects and effects in relation with the present invention can be clearly appreciated through the detailed descriptions concerning the preferred embodiments of the present invention in conjunction with the appended drawings.

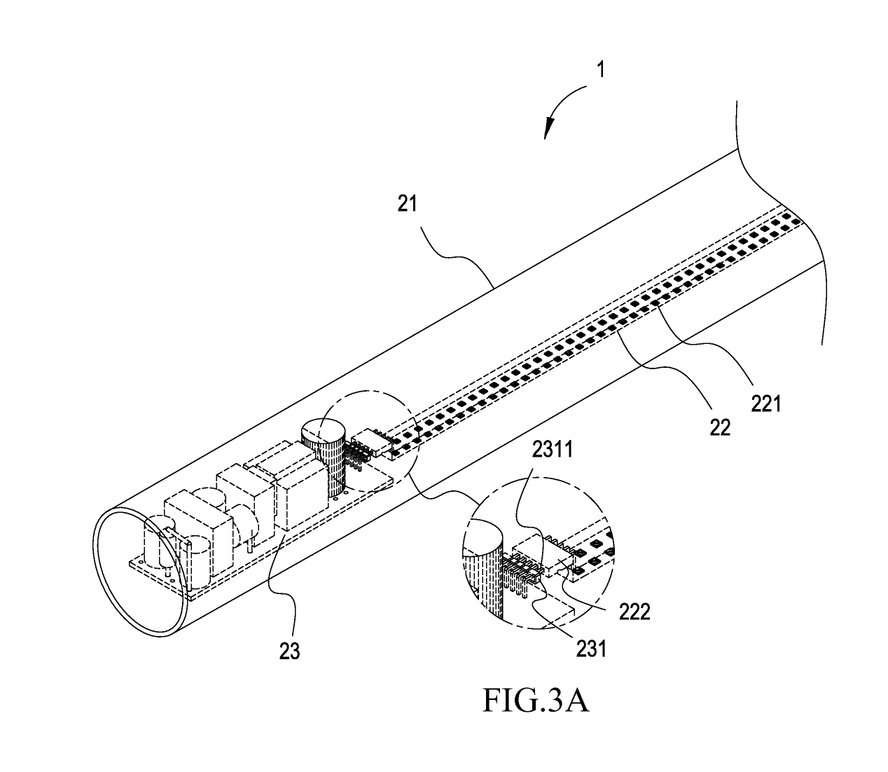

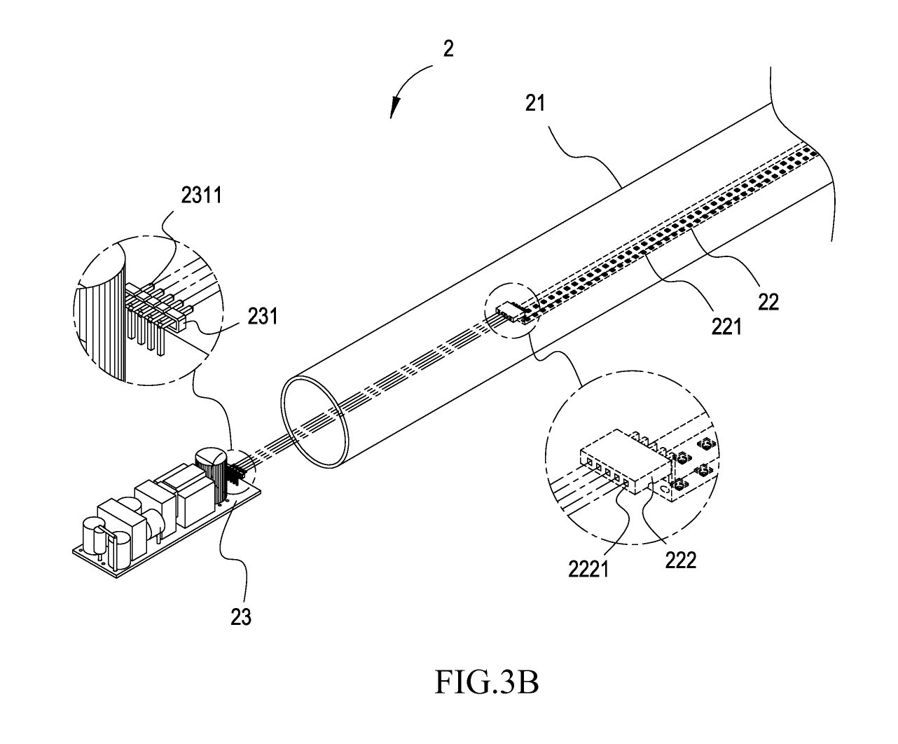

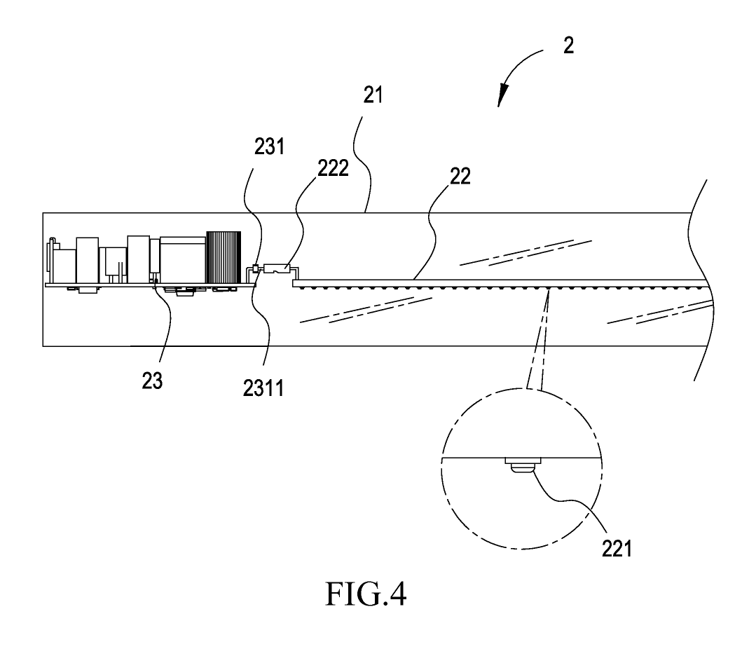

Refer initially to FIGS. 3A, 3B and 4, wherein a stereo assembled structural diagram for a first embodiment, a stereo disassembled structural diagram for the first embodiment and a side view for the first embodiment of the improved drive circuit board connection structure for LED lamp tube according to the present invention are respectively shown. It can be seen that, from the Figures, the LED lamp tube 2 comprises a lamp tube body 21, in which the lamp tube body 21 is internally installed with at least an LED lamp strap 22 having a plurality of LEDs 221 as well as at least a drive circuit board 23 installed on either side of the interior of the lamp tube body 21 and electrically connected to the LED lamp strap 22, and also a connection plug component is respectively installed on the drive circuit board 23 and the LED lamp strap 22. In terms of the present embodiment, the connection plug component on the drive circuit board 23 is a pin header 231 and the connection plug component on the LED lamp strap 22 is a female header 222, with an end of the pin header 231 soldered onto the drive circuit board 23. On the other hand, since an end of the female header 222 is soldered onto the LED lamp strap 22 while the other end thereof includes a plurality of pin holes 2221 corresponding to the pins 2311 on the pin header 231, thus upon inserting the pins 2311 of the pin header 231 to the pin holes 2221 of the female header 222, the drive circuit board 23 soldered with the pin header 231 can be electrically connected to the LED lamp strap 22 soldered with the female header 222 such that the drive circuit board 23 can drive the LED lamp strap 22 to illuminate.

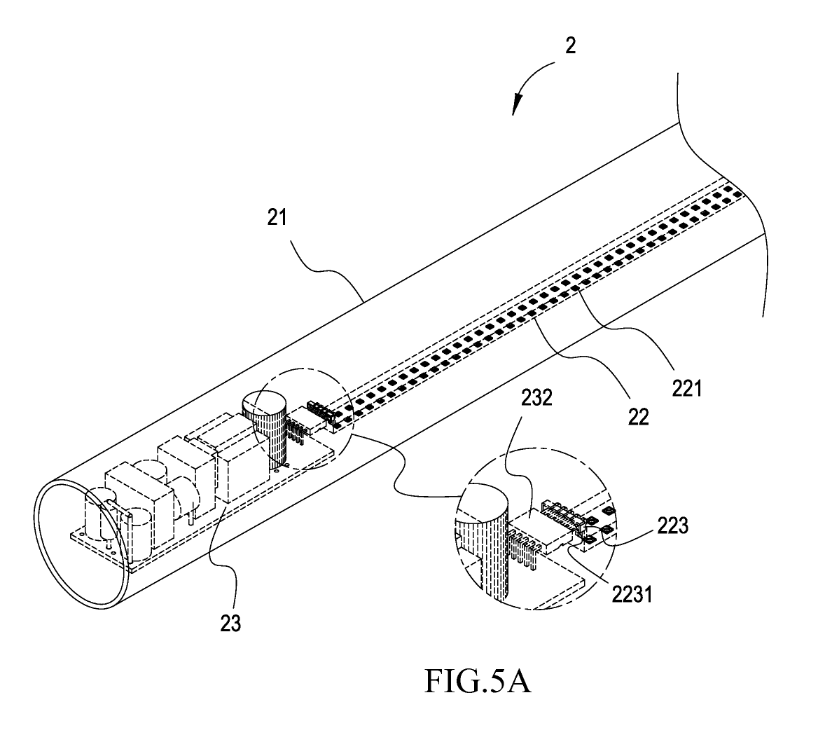

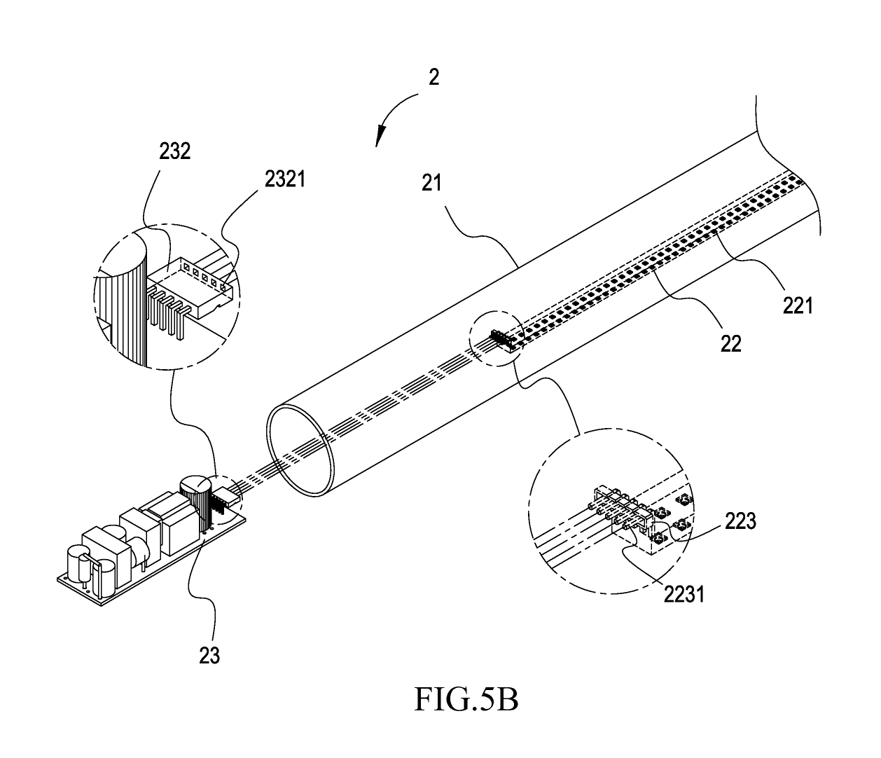

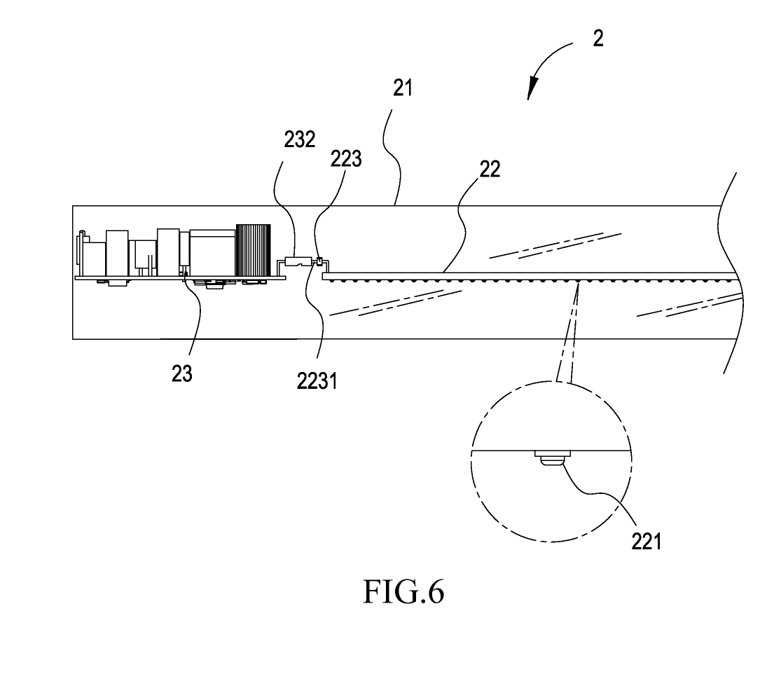

In addition the structure illustrated in the first embodiment as above, it is also possible to employ another structure. The difference from the first embodiment lies in that, as shown in FIGS. 5A, 5B and 6, the connection plug component respectively installed on the drive circuit board 23 and the LED lamp strap 22 may differ, herein the connection plug component on the drive circuit board 23 is a female header 232 and the connection plug component on the LED lamp strap 22 is a pin header 223. An end of the pin header 223 is soldered onto the LED lamp strap 22 (while the other end thereof extends out a plurality of pins 2231 toward the female header 232); besides, an end of the female header 232 is soldered onto the drive circuit board 23 and the other end thereof includes a plurality of pin holes 2321 corresponding to the pins 2231 on the pin header 223. Therefore, upon inserting the female header 232 of the drive circuit board 23 to the pin header 223 of the LED lamp strap 22, the drive circuit board 23 can be electrically connected, by way of the female header 232 soldered thereon, to the LED lamp strap 22 already soldered with the pin header 223 such that the drive circuit board 23 can drive the LED lamp strap 22 to illuminate.

Consequently, it can be clearly appreciated that, from the aforementioned two embodiments, the connection plug component may be a male plug connection structure (e.g., the pin header 231, 223) or a female plug connection structure (e.g., the female header 222, 232), so all components capable of achieving the electrical connection by means of male-female plug connections are deemed to be within the scope of the present invention. Except the pin header and the female header, other components enabling such a function are numerous, thus the descriptions thereof are herein omitted for brevity.

Moreover, only the configuration located at one end is illustrated in the previous two embodiments. Therefore, the technical contents of the present invention indeed apply no matter two separate LED lamp tubes (requiring two drive circuit boards to respectively drive the two separate LED lamps) or a single LED lamp tube (requiring at least a drive circuit board to drive the LED lamp) is installed inside the lamp tube body 21.

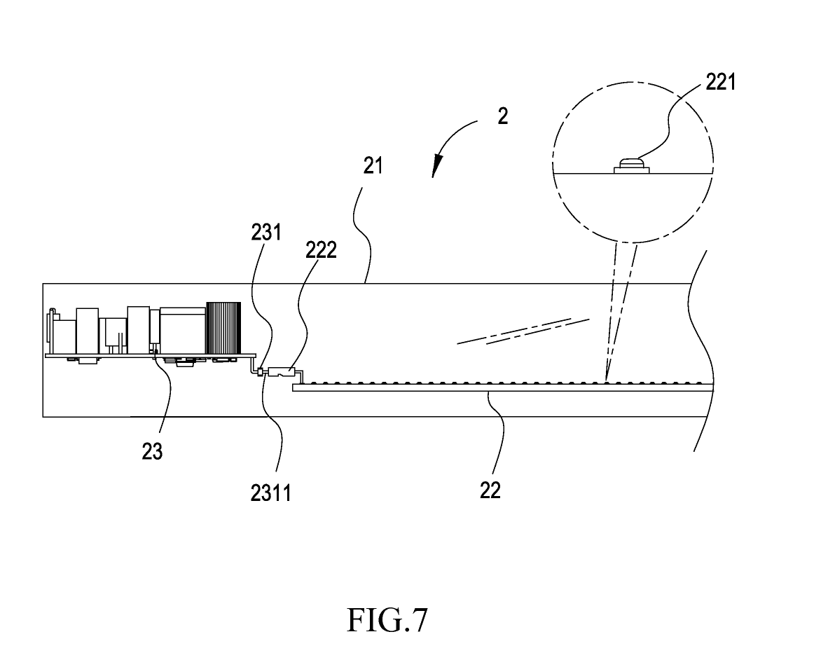

Meanwhile, in addition to the aforementioned two embodiments, in practice, as illustrated in a third embodiment shown by FIG. 7, an end of the pin header 231 on the drive circuit board 23 is soldered onto the backboard of the drive circuit board 23 and an end of the female header 222 is soldered onto a side of the LED lamp strap 22 including a plurality of LEDs 221, so as to keep the LEDs 221 on the LED lamp strap 22 at a certain distance from the lamp tube body 21 such that the shape of the LEDs 221 may not be visible to the user through the lamp tube body 21 from outside to inside when the LEDs 221 emit light. Since the backboard of the LED lamp strap 22 may not be suitable for soldering the female header 222, it is more appropriate to solder an end of the female header 222 onto a side of the LED lamp strap 22 including a plurality of LEDs 221.

Furthermore, except soldering the pin header 231 onto the drive circuit board 23 and the female header 222 onto the LED lamp strap 22, in case that, contrarily, the female plug connection structure is soldered onto the drive circuit board 23 and male plug connection structure is soldered onto the LED lamp strap 22, or otherwise soldering any types of male/female plug connection structures respectively onto the drive circuit board 23 and the LED lamp strap 22, it is possible to solder such a male plug connection structure and female plug connection structure respectively onto the backboard of the drive circuit board and onto the side of the LED lamp strap including a plurality of LEDs, thereby achieving an optimal solution in accordance with the present invention.

Compared with other conventional technologies, the improved lamp tube connector structure for LED lamp tube provided by the present invention further offers the following advantages:

1. The present invention employs the connection of two connection plug components to electrically connect the drive circuit board to the LED lamp strap in order to reduce or even eliminate the inconvenience in assembly operations or interferences among wires, so that the electrical connection can be effectively achieved without using connection wires connecting between the drive circuit board and the LED lamp.

2. After assembly operations, the two connection plug components in the present invention will be connected thereby enabling electric conductivity between the drive circuit board and the LED lamp strap, so the issue concerning connection lines of excessive length in prior art can be resolved.

By way of the aforementioned detailed descriptions for the preferred embodiments according to the present invention, it is intended to better illustrate the characters and spirit of the present invention rather than restricting the scope of the present invention to the preferred embodiments disclosed in the previous texts. Contrarily, the objective is to encompass all changes and effectively equivalent arrangements within the scope of the present invention as delineated in the following claims of the present application.

What is claimed is:

1. An improved drive circuit board connection structure for light emitting diode (LED) lamp tube, wherein the LED lamp tube comprises a lamp tube body, at least an LED lamp strap installed inside the lamp tube body, and at least a drive circuit board installed on either side of the lamp tube body and electrically connected to the LED lamp strap, characterized in that: a connection plug component is respectively installed on the drive circuit board and the LED lamp strap, and by connecting such two different connection plug components, the drive circuit board and the LED lamp strap can be electrically connected thereby driving the LED lamp strap to illuminate.

2. The improved drive circuit board connection structure for LED lamp tube according to claim 1, wherein the connection plug component on the drive circuit board includes at least a male plug connection structure, and the connection plug component on the LED lamp strap is formed with at least a female plug connection structure in correspondence with the male plug connection structure.

3. The improved drive circuit board connection structure for LED lamp tube according to claim 1, wherein the connection plug component on the drive circuit board includes at least a female plug connection structure, and the connection plug component on the LED lamp strap is formed with at least a male plug connection structure in correspondence with the female plug connection structure.

4. The improved drive circuit board connection structure for LED lamp tube according to claim 3, wherein the male plug connection structure may be a pin header and the female plug connection structure may be a female header, and the electrical connection can be accomplished upon inserting the male plug connection structure to the female plug connection structure.

5. The improved drive circuit board connection structure for LED lamp tube according to claim 4, wherein the male plug connection structure may be a pin header and the female plug connection structure may be a female header, and the electrical connection can be accomplished upon inserting the male plug connection structure to the female plug connection structure.

6. The improved drive circuit board connection structure for LED lamp tube according to claim 1, wherein the LED lamp strap includes a plurality of LEDs.

7. The improved drive circuit board connection structure for LED lamp tube according to claim 1, wherein the lamp tube body is of a long-strapped shape.
